(19) United States
(12) Patent Application Publication
(10) Pub. No.: US 2017/0248764 A1
(43) Pub. Date: Aug. 31, 2017

(54) TRANSCEIVERS USING A PLUGGABLE OPTICAL BODY

(71) Applicant: Corning Optical Communications LLC, Hickory, NC (US)

(72) Inventors: Jeffery Alan DeMeritt, Painted Post, NY (US); Christopher Paul Lewallen, Hudson, NC (US); James Phillip Luther, Hickory, NC (US); Gary Richard Trott, San Mateo, CA (US)

(21) Appl. No.: 15/595,125

(22) Filed: May 15, 2017

Related U.S. Application Data
(63) Continuation of application No. PCT/US15/60506, filed on Nov. 13, 2015.
(60) Provisional application No. 62/084,944, filed on Nov. 26, 2014.

(51) Int. Cl. G02B 6/42; G02B 6/32

(52) U.S. Cl. CPC G02B 6/4292; G02B 6/32; G02B 6/42; G02B 6/4204; G02B 6/4214; G02B 6/4246; G02B 6/4249

(57) ABSTRACT

Disclosed are transceivers using a pluggable optical body. In one embodiment the transceiver comprises a transceiver receptacle body and a substrate assembly. The transceiver receptacle body comprises a front side, a rear side and at least one optical channel at the optical interface with the front side having at least one alignment pin and the rear side having at least one cavity. The substrate assembly comprises a substrate supporting at least one active electronic component and the substrate comprising at least one alignment feature for cooperating with the at least one alignment pin of the transceiver receptacle body. In one variation, one or more alignment pins may extend from the front side into the cavity of the transceiver receptacle body.

### PRIORITY APPLICATION

This application is a continuation of International Patent Application Serial No. PCT/US15/60506, filed on Nov. 13, 2015, which claims the benefit of priority under 35 U.S.C. §119 of U.S. Provisional Application Ser. No. 62/084,944, filed on Nov. 26, 2014, the contents of which are relied upon and incorporated herein by reference in their entireties.

### FIELD

The disclosure is directed to transceivers for use in electronic devices. More specifically, the disclosure is directed to transceivers having a pluggable optical body.

### BACKGROUND

As electronic devices move toward operation at faster data rates the electrical interfaces on these devices along with the electrical transmission cables will reach their bandwidth capacity limitations. Additionally, the electronic devices are trending to smaller and thinner footprints. Optical fibers have displaced copper-based connectivity in much of the traditional long-haul and metro telecommunication networks for numerous reasons such as large bandwidth capacity, dielectric characteristics and the like. As consumers require more bandwidth for consumer electronic devices such as smart phones, laptops, tablets and the like optical fibers and optical ports for optical signal transmission are being considered for replacing the conventional copper-based connectivity for these applications. However, there are significant challenges for providing optical connectivity in electronic devices compared with copper-based connectivity. By way of example, devices such as smart phones, laptops and tablets are exposed to rough handling and harsh environments and the consumer will expect optical connectivity to handle these demanding conditions. Further, these types of devices will require a large number of mating/unmating cycles during their lifetime. Consequently, optical connections for consumer application will need to be easy to clean and maintain by the user.

There is an unresolved need for optical connections that may be used for relatively small devices like typical consumer applications such personnel devices such as smart phones, tablets and other consumer devices that have a relatively small footprint. The concepts disclosed herein solve this unresolved need for optical connections.

### SUMMARY

The disclosure is directed to a transceiver using a pluggable optical body. In one embodiment a transceiver comprises a transceiver receptacle body and a substrate assembly. The transceiver receptacle body comprises a front side, a rear side and at least one optical channel at the optical interface with the front side having at least one alignment pin and the rear side having at least one cavity. The substrate assembly comprises a substrate supporting at least one active electronic component and the substrate comprising at least one alignment feature for cooperating with the at least one alignment pin of the transceiver receptacle body.

In another aspect, the transceiver comprises a transceiver receptacle body and a substrate assembly. The transceiver receptacle body comprises a front side, a rear side and at least one optical channel at the optical interface with the front side having a first alignment pin and a second alignment pin, and the rear side has a cavity. The first alignment pin extends from the front side into the cavity and the second alignment pin extends from the front side into the cavity. The substrate assembly comprises a glass substrate supporting at least one active electronic component and the substrate comprising a first alignment feature and a second alignment feature for cooperating with the first alignment pin and the second alignment pin of the transceiver receptacle body.

In yet another aspect, the transceiver comprises a transceiver receptacle body, a substrate assembly and an optical plug body. The transceiver receptacle body comprises a front side, a rear side and at least one optical channel at the optical interface with the front side having a first alignment pin and a second alignment pin, and the rear side has a cavity. The first alignment pin extends from the front side into the cavity and the second alignment pin extends from the front side into the cavity. The substrate assembly comprising a glass substrate supporting at least one active electronic component and the substrate comprising a first alignment feature and a second alignment feature for cooperating with the first alignment pin and the second alignment pin of the transceiver receptacle body. The optical plug body comprising a front side and a rear side, and being sized for fitting into the cavity of the transceiver receptacle body.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a front perspective view of a transceiver along with an optical plug connector attached thereto that may be used with an electronic device according to the concepts disclosed;

FIG. 2 is a partially exploded view of the transceiver of FIG. 1 from the front side along with the optical plug connector;

FIG. 3 is a partially exploded view of the transceiver of FIG. 1 from the rear side along with the optical plug connector;

FIG. 4 is a cross-sectional view of the transceiver along with the optical plug connector of FIG. 1;

FIGS. 5A-5C respectively are a front perspective view, a rear end view and a front end view of the transceiver receptacle body of FIG. 1 depicting the alignment pins extending from the front side of the transceiver receptacle body into the cavity of the transceiver receptacle body;

FIGS. 6-8 are various view of a substrate for supporting at least one active electronic component which is attached to the front side of the transceiver when assembled;

FIGS. 9 and 10 are respectively are a front perspective view and a cross-sectional view of the optical plug body of the optical plug connector of FIG. 1;

FIGS. 11 and 12 are respectively are a rear perspective view and a front perspective view of a fiber organizer of the optical plug connector of FIG. 1;

FIG. 13 is a front perspective view of another embodiment of a transceiver along with the optical plug connector attached thereto that may be used with an electronic device according to the concepts disclosed;

FIG. 14 is a partially exploded view of another embodiment of a transceiver having alignment pins configured as discrete components according to the concepts disclosed;

FIG. 15 is a cross-sectional view of the transceiver of FIG. 14 along with the optical plug connector in an assembled state, but without the optical fibers; and

FIGS. 16-20 are various views of another embodiment of a transceiver along with the optical plug connector that uses a different retention structure for securing the optical plug connector to the transceiver.

### DETAILED DESCRIPTION

Reference will now be made in detail to the embodiments of the disclosure, examples of which are illustrated in the accompanying drawings. Whenever possible, like reference numbers will be used to refer to like components or parts.

The transceivers disclosed herein may receive a pluggable optical plug connector and enable high-speed data applications for transmitting optical signals to electronic devices such as active optical cable (AOC) assemblies, server blades, switches, routers and other types equipment that require high-speed data transmission. Consequently, the transceiver may be mounted to a circuit board or other like device while the optical plug connector can be manufactured in another independent manufacturing operation for improving manufacturing efficiency by having separate manufacturing work streams. Further, the transceivers provide the ability to reconfigure or disconnect the device by removing the optical plug connector from the transceiver as desired. The transceivers also provide passive alignment between the transceiver and the optical plug connector. The transceivers disclosed provide a relatively small and compact footprint so that they are useful with a variety of electronic devices. High-speed data applications such as 5 Gigabits/sec or greater are possible and in certain embodiments that use a glass substrate the data rates can extend to 25 Gigabits/sec or greater.

Transceivers convert transmit/receive optical signals from the optical plug connector to electrical signals and vice versa using one or more lenses of the transceiver to transmit/receive the optical signals to a substrate having active at least one active electronic component aligned with the respective lenses. By way of example, the one or more lenses of the transceiver receptacle body are used for collimating or focusing the light from the transmission channel(s) of the optical plug connector and are optically coupled to an active electronic component such as a photodiode or the like that is supported by the substrate. The receive channels of the optical plug connector obtains its signals from an active electronic component supported by the substrate such as a laser like a vertical-cavity surface-emitting laser (VCSEL) that is aligned and in communication with the lens of the transceiver for transmission of the optical signals of the optical plug connector when assembled. The transceiver along with the optical plug connector according to the concepts disclosed provide quick and easy connectivity with a footprint that is advantageous for use with electronic devices along with simplified manufacturing. Additionally, the transceiver provides a robust and reliable design for applications that may desire mating, unmating or reconfiguring the electronic device.

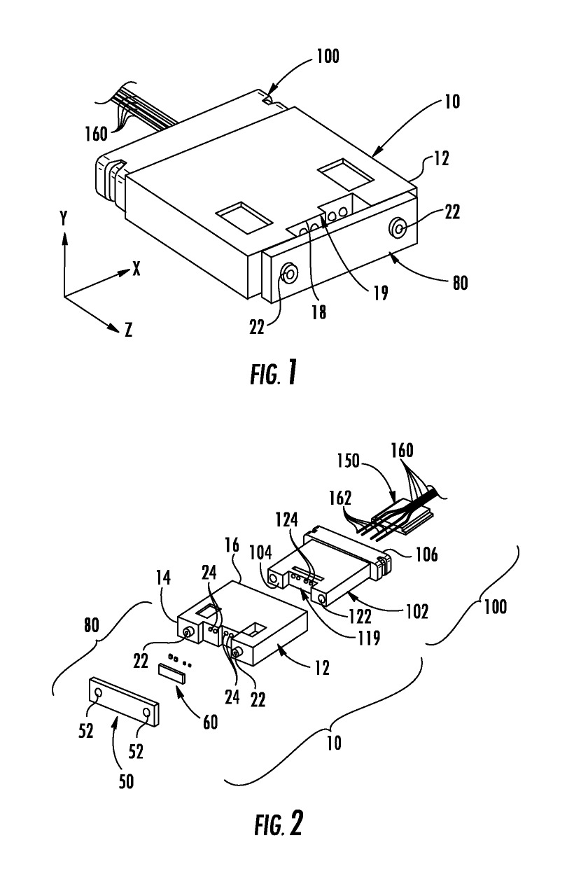

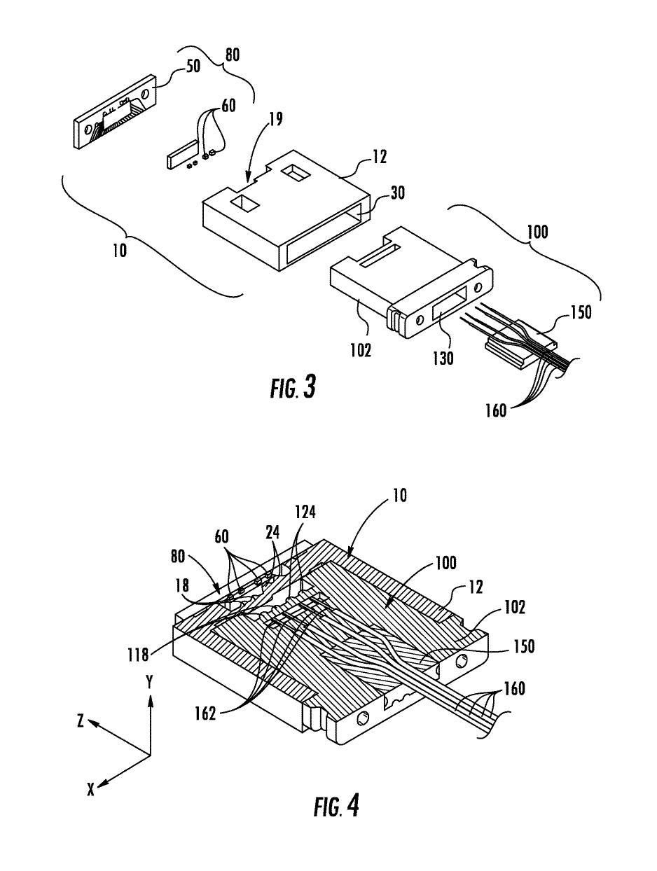

FIG. 1 is a front perspective view of an explanatory transceiver 10 along with an explanatory optical plug connector 100 attached thereto that may be used with an electronic device (not shown) and FIGS. 2 and 3 are a partially exploded views of the transceiver 10 and optical plug connector 100. FIG. 4 is a cross-sectional view of the transceiver 10 mated with the optical plug connector 100 showing the alignment of the optical fibers 160 with the optical channels 118 of the optical plug body 102 of the optical plug connector 100 that are aligned with the optical channels 18 of the transceiver receptacle body 12, and which are aligned with the active electronic components 60 of substrate assembly of the transceiver 10. Transceiver 10 is useful for converting optical signals received from optical plug connector 100 on the transmit optical channel(s) into electrical signals for the electronic device and converting electrical signals received from the electronic device to optical signals for transmission to the optical plug connector 100 on the receive optical channels of the transceiver 10.

Transceiver 10 comprises a transceiver receptacle body 12 having a front side 14, a rear side 16 and at least one optical channel 18 at an optical interface 19. In this embodiment, optical interface 19 has four optical channels 18 with two receive optical channels and two transmit optical channels, but other embodiments may include any suitable number of optical channels. Further, the number of transmit and receive channels need not be equal in number. The at least one optical channel 18 may comprise a transmit optical channel 18T having a lens 24 at the front side and a receive optical channel 18R having a lens 24 at the front side 14. Front side 14 may optionally include a stepped profile 15 for the optical interface 19. Using a stepped profile 15 allows the transmit and receive lens 24 to be positioned at a different focal distance from the active electronic components 60 of the substrate assembly 80, thereby allowing tailored (e.g., improved) optical coupling for the transmit and receive channels. Consequently, the stepped profile 15 comprises a first surface 15a and a second surface 15b with a first lens 24 disposed on the first surface 15a and a second lens 24 disposed on the second surface 15b.

Front side 14 of transceiver receptacle body 12 also has at least one alignment pin 22. As depicted, front side 14 includes two alignment pins disposed on opposite sides of the optical interface 19 and are disposed on ledges portions (not numbered) that extend in the Z-direction beyond the optical interface 19 by a predetermined distance. Ledges are used as a stop and spacing the active electronic components 60 of substrate assembly 80 the desired distance from lenses 24. As shown in FIG. 3, the rear side 16 of the transceiver receptacle body 12 has at least one cavity 30 for receiving a portion of the optical plug connector 100.

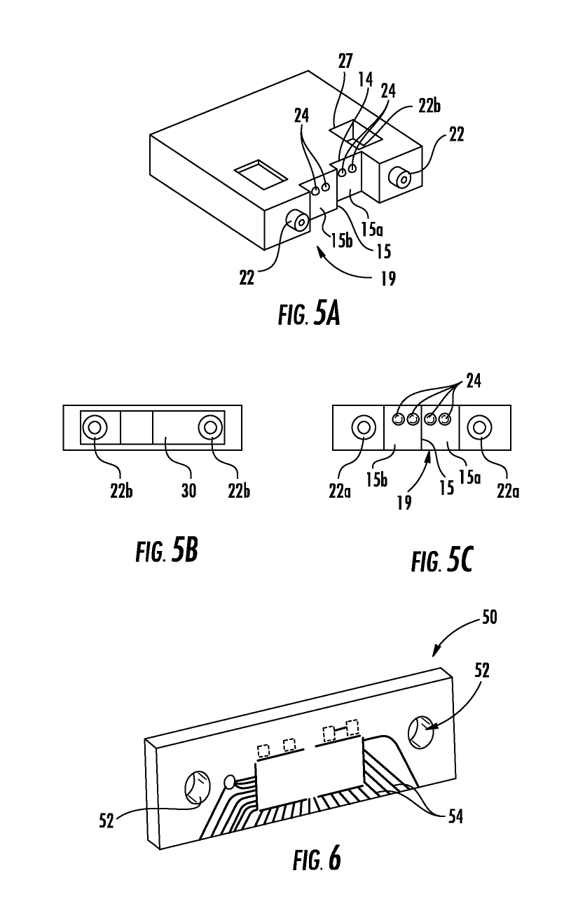

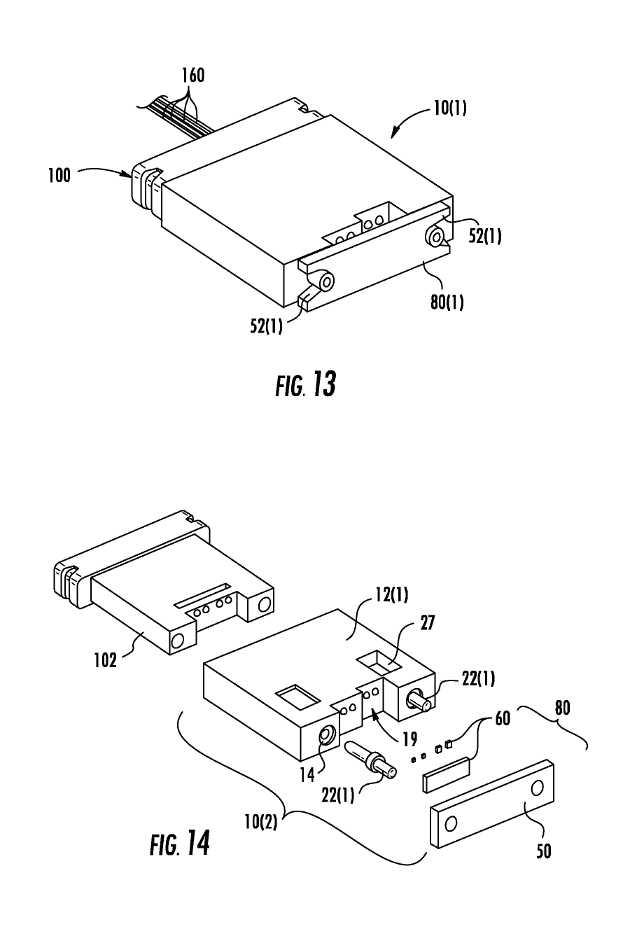

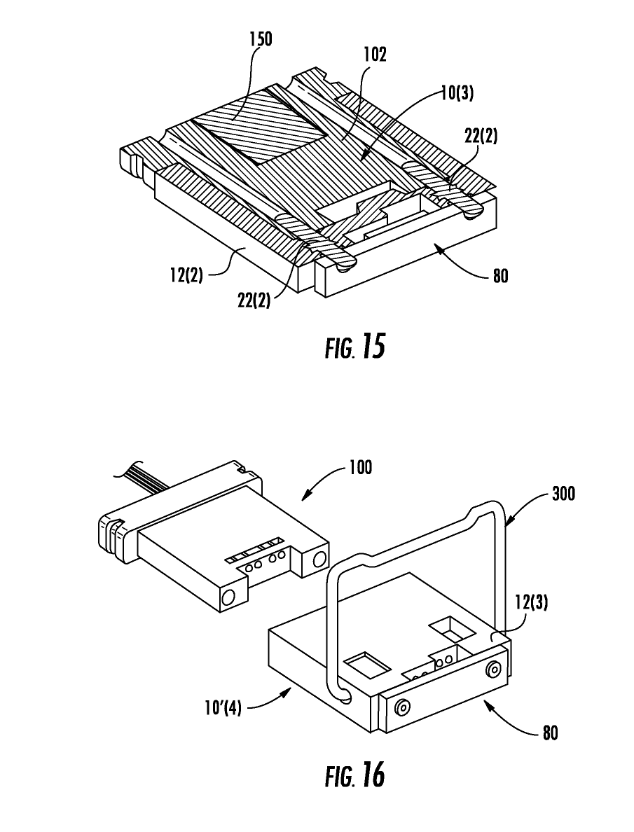

FIGS. 5A-5C respectively are a front perspective view, a rear end view and a front end view of the transceiver receptacle body 12 depicting the alignment pins 22 along with other features. Alignment pin(s) 22 extend from the front side 14 of the transceiver receptacle body 12 into the cavity 30 of the transceiver receptacle body 12. In other words, the transceiver receptacle body 12 comprises a first alignment pin 22 that extends from the front side 14 into the cavity 30, and a second alignment pin 22 that extends from the front side 14 into the cavity 30. As shown in FIG. 1, when assembled the alignment pins 22 of the transceiver receptacle body 12 are received in the alignment features 52 such as alignment bores of substrate 50 for suitably aligning the optical channels 18 at the optical interface 19 with the respective active electronic components 60. For instance, the transmit optical channels of the transceiver 10 are suitably aligned with photodiodes on the transmit channels and the receive optical channels of the transceiver 10 are suitably aligned with VCSELs on the receive channels. The portion of the alignment pins 22 that extend into cavity 30 are used for aligning the optical interface 119 (and the optical channels) of the optical plug connector 100 with the optical channels 18 of the transceiver receptacle body 12. Alignment pins 22 may be integrally formed with the transceiver receptacle body 12 as shown in this embodiment or the alignment pins may be discrete components that fit into the transceiver receptacle body 12 or are molded therein (FIGS. 14 and 15).

Transceiver 10 also includes a substrate assembly 80 comprising a substrate 50 supporting at least one active electronic component 60. Substrate 50 comprises at least one alignment feature 52 for cooperating with the at least one alignment pin 22 of the transceiver receptacle body 12. By way of example, alignment feature 52 may be one or more bores (e.g., holes) in the substrate for precision alignment with the alignment pins 22 of the transceiver receptacle body. Ideally, the alignment features 52 are precise enough with the alignment pins for allowing passive alignment; however, active alignment may also be used with the concepts disclosed. Further, optical alignment with the active electronic components 60 may also depend of the precise placement of active electronic components 60 onto the substrate 50. Substrate 50 may be formed from any suitable material such as a conventional circuit board material having electrical traces and using wire bonding for electrical connection, but may also be made of other materials as desired. For instance, substrate 50 may be formed from a glass material for enabling high-speed applications such as up to 25 gigabits/second or faster, whereas a convention circuit board may have difficulties supporting speeds beyond 10 gigabits/second.

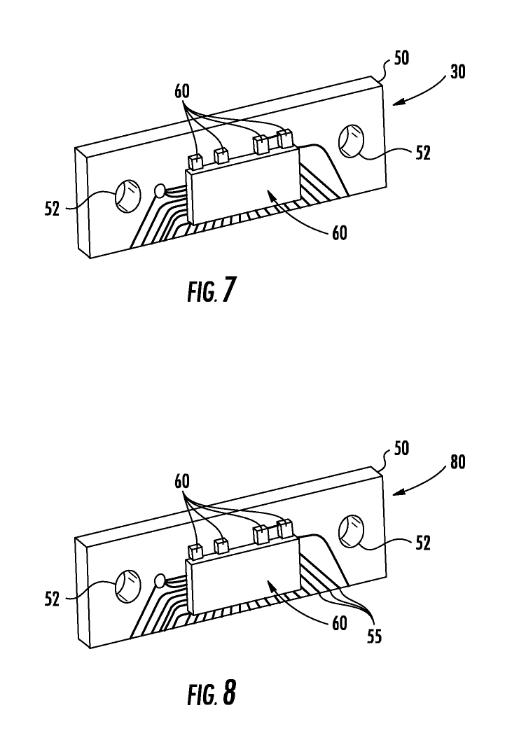

FIGS. 6-8 are various view of substrate 50 formed of a glass material for supporting at least one active electronic component 60. When assembled, substrate 50 is attached to the front side 14 of the transceiver 10 using the alignment features. As shown, this embodiment may use a combination of a round hole and a slot for alignment features 52 for inhibiting tensile forces during assembly. Using a glass material for substrate 50 may also require other techniques for manufacturing or structure. For instance, the electrical traces 54 on the substrate may be a plurality of vias formed on the glass material as depicted in FIG. 6. FIG. 7 depicts a trans-impedance amplifier (TIA) integrated circuit (lower component) as one of the active electronic components 60 supported by the substrate 50, besides the conventional active electronic components (i.e., upper components such as photodiodes and VCSELs) for the transceiver 10. The active electronic components 60 may be flip-chip bonded to the substrate 50, which supports faster speeds compared with conventional wire bonds used for applications up to 10 gigabits/second and can also be used.

FIGS. 7 and 8 show the backside of the substrate assembly 80 used for converting the optical signals to electrical signals and vice versa and may have any suitable arrangement or layout. The substrate assembly 80 includes at least one active component 60 aligned with at least one optical channel 18 of the transceiver receptacle body 12 when properly aligned and attached to transceiver receptacle body 12.

The substrate assembly 80 is attached and spaced at a suitable distance from the lenses 24 using ledges or other suitable structure, which provides the desired z-direction distance between the active electronic components 60 and the lenses 24. As discussed, the substrate assembly 80 may use a passive and/or active alignment for positioning the substrate assembly 80 in the X-direction and Y-direction. Active electronic component(s) are an electro-optical component used for transmitting or receiving optical signals to/from the optical channels of the transceiver 10. By way of example, the active component is a photodiode or other similar device for receiving optical signals or a vertical-cavity surface-emitting laser (VCSEL) for transmitting optical signals, thereby providing one or more transmit and receive channels. Additionally, the receptacle circuit board assembly may include further electronic components such as transimpedance amplifiers (TIAs) or laser drivers arranged as a first circuit portion and/or a second circuit portion for processing signals and other electronics such as integrated circuits (ICs) like clock and data recovery (CDR), laser drivers serializer/deserializer (SerDes), and the like on the circuit board.

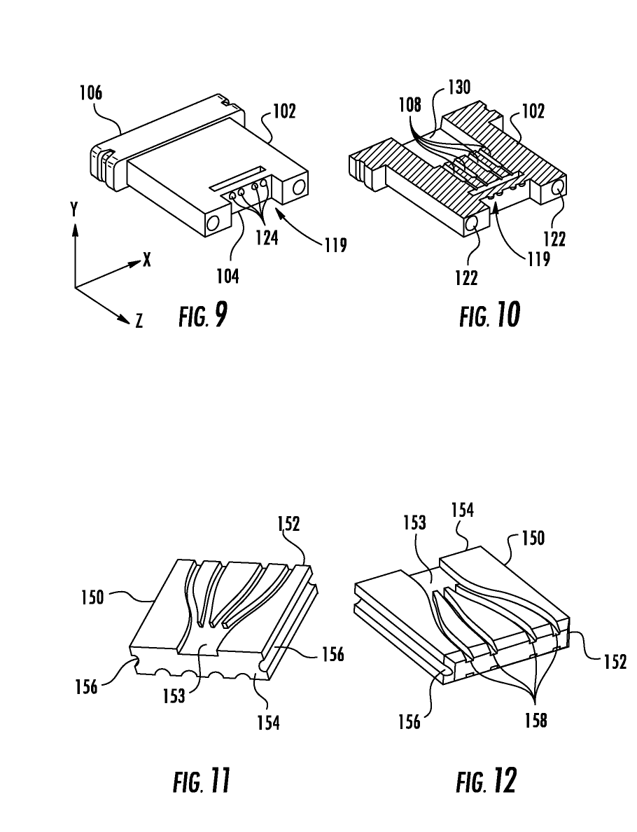

FIGS. 2 and 3 depict optical plug connector 100 respectively in front and rear partially exploded views. Optical plug connector 100 includes an optical plug body 102 comprising a front side 104 and a rear side 106 and is sized for fitting into a cavity 30 of the transceiver receptacle body 12. As best shown in FIGS. 9 and 10, optical plug body 102 comprises an optical interface 119 having as least one lens 124 at the front side 104. Generally speaking, optical plug body 102 has a corresponding number of lenses 124 at the optical interface 119 that match the number of optical channels 18 of the transceiver receptacle body 12. In other words, each lens 124 of the optical plug body 102 corresponds to the each optical channel 18 of the optical transceiver 10 so that each individual optical fiber 160 can communicate with a respective optical channel 18 of the transceiver 10. Optical plug body 102 also comprises at least one alignment feature 122 on the front side 104 for cooperating with the at least one alignment pin 22 of the transceiver receptacle body 12. Optical plug body 102 also includes fiber guides 108 for receiving the ends 162 of optical fibers 160 as depicted in FIG. 4. Using lenses 124 on the front side 104 of optical plug body 102 provides a larger misalignment tolerance with the transceiver receptacle body 12. The fiber guide spacing is matched to the lenses 124 and provides a proper distance for avoiding optical cross-talk in the transceiver 10. Optical plug body 102 may be keyed to the cavity 30 for the proper orientation or to have a one-way fit. Additionally, optical plug body 102 includes ledges (not numbered) outboard of the optical interface 119 for providing the desire Z-direction spacing between lenses 124 and transceiver receptacle body 12. Optical plug body 102 may be secured to the transceiver receptacle body 12 in any suitable mechanical fashion such as a snap-fit, pins, latches, a rotating bail or the like.

In this embodiment, the optical plug connector 100 optionally further comprises a cavity 130 at the rear side 106. Cavity 130 is sized and shaped for receiving a fiber organizer 150 as best shown in FIGS. 11 and 12. Fiber organizer 150 is useful for providing a fan-out for the optical fibers 160 to have the desired spacing with the fiber guides 108 of the optical plug body 102. For instance, fiber organizer 150 allows the optical fibers 160 to be spaced from a ribbon where the optical fibers 160 are closely spaced together to the larger spacing of optical channels of the transceiver 10. Further, the fiber organizer 150 may be used as jig for processing the ends 162 of the optical fibers 160 after being secured thereto such as laser stripping and/or cutting as desired. As shown, fiber organizer 150 has a common channel 153 at a rear side 154 that breaks off into individual channels 158 at the front side 152 for separating and spacing the optical fibers 160. Fiber organizer 150 may also have keying features or guides 156 that align it to the optical plug body 102. Fiber organizer 150 may be secured to optical plug body 102 in any suitable mechanical fashion such as a snap-fit, adhesive or the like. Once assembled, the optical plug connector 100 is a stand-alone assembly that may be attached, removed, and re-attached to any suitable transceiver and may be connected to any suitable device or be a jumper assembly.

FIG. 13 is a front perspective view of another embodiment of a transceiver 10(1) along with optical plug connector 100 attached thereto that is similar to transceiver 10, but uses a different substrate assembly 80(1). Substrate assembly 80(1) has alignment features 52(1) configured as open slots. Open slots relieve assembly stresses on the substate.

FIG. 14 is a partially exploded view of another embodiment of a transceiver 10(2) similar to transceiver 10, but having alignment pins 22(1) configured as discrete components. Alignment pins 22(1) may be configured to be inserted into the front side 14 of the transceiver receptacle body 12. Alternatively, FIG. 15 is a cross-sectional view of another transceiver 10(3) that is similar to transceiver 10, but having alignment pins 22(2) configured as discrete components and molded into the transceiver receptacle body 12(2).

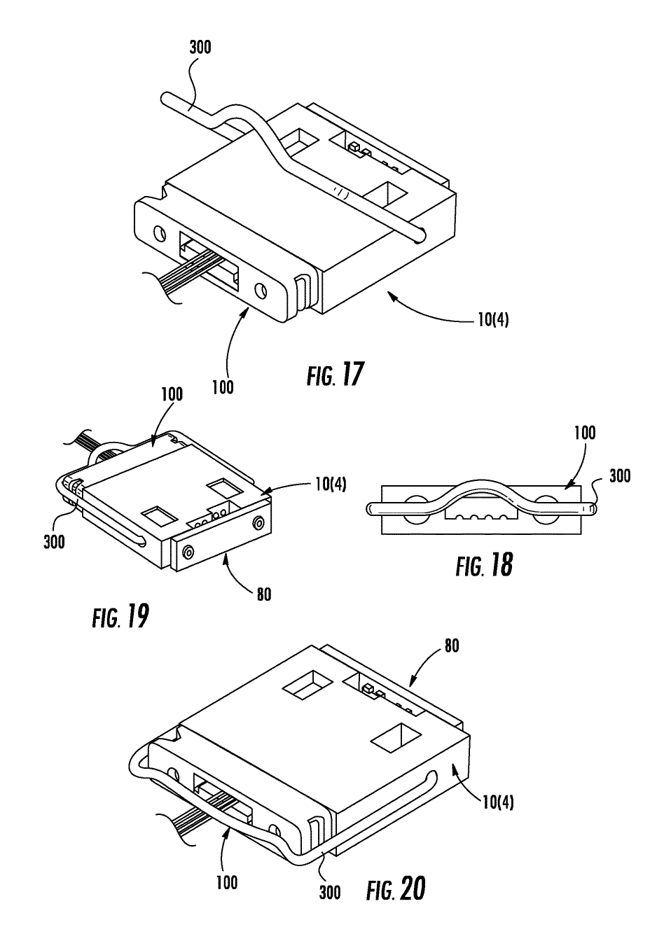

FIGS. 16-20 are various views of another embodiment of a transceiver 10(4) that is similar to transceiver 10, but uses a bail 300 for securing the optical plug connector 100 to the transceiver 10(4). Transceiver 10(4) uses a transceiver plug body 12(3) that is modified for mounting bail 300 to the sides in a rotating fashion. Consequently, when the optical plug connector 100 is fully-inserted into the transceiver 10(4) (FIG. 17), then the bail 300 may be rotated to capture optical plug connector 100 in position and secure the same. FIGS. 18-20 depict various view of the optical plug connector 100 secured to the transceiver 10(4).

Although the disclosure has been illustrated and described herein with reference to embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A transceiver, comprising:
a transceiver receptacle body having a front side, a rear side and at least one optical channel at the optical interface, the front side having at least one alignment pin and the rear side having at least one cavity; and
a substrate assembly comprising a substrate supporting at least one active electronic component and the substrate comprising at least one alignment feature for cooperating with the at least one alignment pin of the transceiver receptacle body.

2. The transceiver of claim 1, wherein the at least one alignment pin extends from the front side into the cavity of the transceiver receptacle body.

3. The transceiver of claim 2, wherein the at least one alignment pin is integrally formed with the transceiver receptacle body.

4. The transceiver of claim 1, wherein the substrate comprises a glass material.

5. The transceiver of claim 1, wherein the at least one optical channel comprises a transmit optical channel having a lens at the front side and a receive optical channel having a lens at the front side.

6. The transceiver of claim 1, wherein the front side has a stepped profile for an optical interface.

7. The transceiver of claim 6, wherein the stepped profile comprises a first surface and a second surface, and a first lens is disposed on the first surface and a second lens is disposed on the second surface.

8. The transceiver of claim 1, wherein the transceiver receptacle body comprises a first alignment pin that extends from the front side into the cavity and a second alignment pin that extends from the front side into the cavity.

9. The transceiver of claim 1, further comprising an optical plug body comprising a front side and a rear side, and being sized for fitting into the cavity of the transceiver receptacle body.

10. The transceiver of claim 9, wherein the optical plug body comprises at least one lens at the front side.

11. The transceiver of claim 9, wherein the optical plug body comprises at least one alignment feature on the front side for cooperating with the at least one alignment pin of the transceiver receptacle body.

12. The transceiver of claim 9, the optical plug body further comprising a cavity at the rear side and a fiber organizer being received in the optical plug body.

13. The transceiver of claim 1, further comprising at least one optical fiber aligned for optical communication with the at least one active electronic component.

14. A transceiver, comprising:
a transceiver receptacle body having a front side, a rear side and at least one optical channel at the optical interface, the front side having a first alignment pin and a second alignment pin, and the rear side having a cavity, wherein the first alignment pin extends from the front side into the cavity and the second alignment pin extends from the front side into the cavity; and
a substrate assembly comprising a glass substrate supporting at least one active electronic component and the substrate comprising a first alignment feature and a second alignment feature for cooperating with the first alignment pin and second alignment pin of the transceiver receptacle body.

15. The transceiver of claim 14, wherein the first alignment pin and the second alignment pin are integrally formed with the transceiver receptacle body.

16. The transceiver of claim 14, wherein the at least one optical channel comprises a transmit optical channel having a lens at the front side and a receive optical channel having a lens at the front side.

17. The transceiver of claim 14, wherein the front side has a stepped profile for an optical interface.

18. The transceiver of claim 17, wherein the stepped profile comprises a first surface and a second surface, and a first lens is disposed on the first surface and a second lens is disposed on the second surface.

19. The transceiver of claim 14, further comprising an optical plug body comprising a front side and a rear side, and being sized for fitting into the cavity of the transceiver receptacle body.

20. The transceiver of claim 19, wherein the optical plug body comprises at least one lens at the front side.

21. The transceiver of claim 19, wherein the optical plug body comprises at least one alignment feature on the front side for cooperating with the at least one alignment pin of the transceiver receptacle body.

22. The transceiver of claim 15, the optical plug body further comprising a cavity at the rear side and a fiber organizer being received in the optical plug body.

23. The transceiver of claim 19, further comprising at least one optical fiber aligned for optical communication with the at least one active electronic component.

24. A transceiver, comprising:
a transceiver receptacle body having a front side, a rear side and at least one optical channel at the optical interface, the front side having a first alignment pin and a second alignment pin, and the rear side having a cavity, wherein the first alignment pin extends from the front side into the cavity and the second alignment pin extends from the front side into the cavity;
a substrate assembly comprising a glass substrate supporting at least one active electronic component and the substrate comprising a first alignment feature and a second alignment feature for cooperating with the first alignment pin and second alignment pin of the transceiver receptacle body; and
an optical plug body comprising a front side and a rear side, and being sized for fitting into the cavity of the transceiver receptacle body.

25. The transceiver of claim 24, wherein the first alignment pin and the second alignment pin are integrally formed with the transceiver receptacle body.

26. The transceiver of claim 24, wherein the at least one optical channel comprises a transmit optical channel having a lens at the front side and a receive optical channel having a lens at the front side.

27. The transceiver of claim 24, wherein the front side has a stepped profile for an optical interface.

28. The transceiver of claim 27, wherein the stepped profile comprises a first surface and a second surface, and a first lens is disposed on the first surface and a second lens is disposed on the second surface.

29. The transceiver of claim 24, the optical plug body comprising a front side and a rear side, and being sized for fitting into the cavity of the transceiver receptacle body.

30. The transceiver of claim 29, wherein the optical plug body comprises at least one lens at the front side.

31. The transceiver of claim 29, wherein the optical plug body comprises at least one alignment feature on the front side for cooperating with the at least one alignment pin of the transceiver receptacle body.

32. The transceiver of claim 24, the optical plug body further comprising a cavity at the rear side and a fiber organizer being received in the optical plug body.

33. The transceiver of claim 24, further comprising at least one optical fiber aligned for optical communication with the at least one active electronic component.
